(19) United States
(12) Patent Application Publication
(10) Pub. No.: US 2014/0161980 A1
(43) Pub. Date: Jun. 12, 2014

(54) METHODS AND FORMULATIONS FOR SPRAY COATING SOL-GEL THIN FILMS ON SUBSTRATES

(71) Applicant: CORNING INCORPORATED, CORNING, NY (US)

(72) Inventors: Melissa Danielle Cremer, Seattle, WA (US); Shandon Dee Hart, Corning, NY (US); David Henry, Fontaine le Port (FR); Shawn Michael O'Malley, Horseheads, NY (US); Vitor Marino Schneider, Painted Post, NY (US)

(73) Assignee: CORNING INCORPORATED, CORNING, NY (US)

(21) Appl. No.: 14/095,217

(22) Filed: Dec. 3, 2013

Related U.S. Application Data
(60) Provisional application No. 61/735,081, filed on Dec. 10, 2012.

(51) Int. Cl. C09D 1/00

(52) U.S. Cl. CPC C09D 1/00
USPC 427/379; 427/372.2; 427/397.7; 427/384; 106/287.19

(57) ABSTRACT

Methods and formulations are provided for: selecting a sol-gel precursor containing a material for forming a thin film layer on a substrate; selecting a solvent having a boiling point at or above a solvent boiling point threshold and a viscosity at or below a solvent viscosity threshold; combining the sol-gel and the solvent into a mixture; applying the mixture onto a surface of the substrate; permitting the mixture to spread and level on the surface; and at least one of drying and curing the mixture to form the thin layer on the substrate.

### CROSS-REFERENCE TO RELATED APPLICATIONS

This application claims the benefit of priority under 35 U.S.C. §119 of U.S. Provisional Application Ser. No. 61/735,081, filed on Dec. 10, 2012, the content of which is relied upon and incorporated herein by reference in its entirety.

### BACKGROUND

The present disclosure relates to methods and formulations for spray coating sol-gel thin films on substrates.

The sol-gel process is a wet chemical technique widely used in the fields of materials science and ceramic engineering, primarily for producing metal oxides. The sol-gel process starts from a colloidal solution (a so-called “sol”) that acts as a precursor for an integrated network (a so-called “gel”) of either discrete particles or network polymers. Typical precursors are metal alkoxides and metal salts (such as chlorides, nitrates and acetates), which undergo various forms of hydrolysis and polycondensation reactions. One of the applications for sol-gels is the production of thin films on substrates. The conventional approach is to apply the sol-gel onto the substrate via spin coating or dip coating. While some may claim that spray coating is a viable option for application of sol-gels to substrates, the reality is that conventional spray coating techniques and formulations are not satisfactory for achieving highly uniform thin films on the order of about 1 um or less.

Although spray coating is a widely used coating technique and exhibits low cost advantages, large area coating capability, complex coating shape capability, minimal coating material waste, and potential for coating uniformly (edge-to-edge), spray coating is generally limited to relatively thick coatings. The reality in the art is that spray coating processes are generally not employed commercially in the production of precision thin film coatings, such as precision optical coatings, where the films need to be very thin (e.g., less than about 1 micron), and where very good control of layer thickness is required. The reason that spray coating has been rejected for use in the application of thin film sol-gels to substrates is that when spray droplets initially impact a surface of the substrate, they form a relatively rough surface layer due to the initially spherical nature of the droplets. Consequently, it becomes increasingly difficult to achieve uniformity in the thickness of the applied films as the film thickness requirement decreases.

Accordingly, there are needs in the art for new methods and formulations for spray coating sol-gel thin films on substrates.

### SUMMARY

It has been discovered that in order to successfully employ spray coating techniques in the application of a sol-gel liquid film to a substrate (i.e., to achieve acceptable uniformity in the thickness of the film, especially a thin film), many conditions must be satisfied. The liquid film should exhibit suitable wetting behavior on the surface of the substrate, so that the spray droplets both level and spread on the surface. In general, the leveling and spreading would be achieved when the surface energy/surface tension of the liquid film is low. It has been discovered, however, that the surface energy/surface tension of the coating material should not be too low, since surface energy itself is the main driving force for a liquid film to achieve suitable leveling. The viscosity of the liquid film is also preferably relatively low so that the liquid material can easily flow, and therefore level itself. It is also useful to minimize the size of the lateral spatial disturbances in the liquid film, and therefore, for example, minimizing spray droplet size is helpful. In addition, the liquid formulation should be compatible with the colloidal nanoparticles of the sol so as not to promote agglomeration or premature viscosity increases.

It has been observed that the leveling speed of the liquid film is dependent on the thickness of the film, since the solid substrate surface creates viscous drag against the leveling flow of the liquid film. Molecules of the liquid film that are closer to the solid substrate experience a greater viscous drag, thus it is especially difficult for thin films to level themselves, and the leveling speed slows down exponentially as the film thickness decreases. As the film leveling speed becomes very slow, the film cannot level in a practical amount of time before the viscosity of the liquid film increases (during the drying process) to such an extent that further leveling is inhibited. Using typical prior art methods, the drying process may cause the liquid film to become a solid before suitable leveling has been achieved, resulting in non-uniform films.

These leveling and spreading effects may summarized by the following leveling equation:

$${T}_{1 / 2} ∝ \frac{{η}_{L} \cdot {λ}^{4}}{γ \cdot {h}^{3}}$$

where T_{1/2} is the time for a disturbance to level to one-half an original height, η is viscosity (at low shear rates), λ is the lateral wavelength of the disturbance, γ is the surface tension, and h is the average film thickness.

The 3^{rd}-power dependence of the leveling time versus the film thickness makes clear that the challenges in spray coating of very thin films are not trivial and require great care and consideration.

It has been discovered that level thin films through spray coating of sol-gels may be achieved by increasing the drying time of the liquid film through use of slow-drying (so-called high-boiling-point) solvents in the coating formulation. The addition of a high-boiling-point solvent to a sol-gel cannot be done without extreme care because many such solvents are not suitable in the spray coating context—indeed, many solvents will actually destroy or severely degrade certain desirable properties of the resulting coating material. Consequently, in the context of spray coating of sol-gel liquids, the particular compositions of the high-boiling-point solvents should be carefully selected and the solvents should be added in quantities that are compatible with the particular sol-gel materials. These two factors should be chosen so as not to cause instability of the sol, which may manifest as one or more of: an aggregation or growth of colloidal material in the sol, rapidly changing viscosity, an unstable viscosity in storage (e.g., between several hours and a number of days), cloudiness, or gellation. If careful consideration of the particular composition of the solvent, the quantity of the solvent, and the sol-gel material is not made, then one or more of the above manifestations may render the sol unusable or impractical for industrial purposes. Indeed, for example, aggregation or growth of colloidal material in the sol may lead to significant increases in viscosity or film cloudiness, neither of which is desirable for many applications, in particular, optical applications.

As noted above, the viscosity of the liquid film is preferably relatively low so that the liquid material can easily flow, and therefore level itself during the coating process. In contrast, many high-boiling-point solvents have a relatively high viscosity. Such high viscosity is counter-productive for the efficient film leveling and spreading required for spray coating sol-gels onto substrates, and will cause noticeable degradations in film uniformity, especially for very thin films.

The conventional approaches to employing high-boiling-point solvents in sol-gel mixtures have not recognized the disadvantageous effects that the high-viscosity solvents have introduced. Consequently, the teachings of numerous publications, such as U.S. Pat. No. 6,463,760, EP 486393A1, U.S. Pat. No. 7,507,436, and others would lead artisans to employ high-viscosity, high-boiling-point solvents in sol-gel mixtures, some in the context of spray coating. It has been discovered, however, that such teachings are not satisfactory for uniform thin film applications, such as at or below about 1 um thickness. Indeed, it has been discovered that certain low-viscosity, high-boiling-point solvents are compatible with certain selected sol-gel formulations, some only in specific quantities, and that these solvents are superior to those previously used in creating thin, uniform sol-gel coatings using spray coating processes.

In accordance with one or more embodiments herein, a method includes: selecting sol-gel precursor containing a material for forming a thin film layer on a substrate; selecting a solvent having a boiling point at or above a solvent boiling point threshold and a viscosity at or below a solvent viscosity threshold; combining the sol-gel and the solvent into a mixture; applying the mixture onto a surface of the substrate; permitting the mixture to spread and level on the surface; and at least one of drying and curing the mixture to form the thin layer on the substrate.

The mixture is stable for a time period sufficient to achieve the spreading and leveling step. By way of example, being stable includes stability of a solution of the sol-gel, where such stability is characterized by at least one of: substantially no aggregation or growth of colloidal material in the solution, substantially no rapid change in viscosity, substantially no unstable viscosity in storage, substantially no cloudiness, and substantially no gellation. Additionally or alternatively, being stable includes the ability to exhibit substantially no viscosity change in storage for at least one of: (i) at least 2 hours, (ii) at least 4 hours; (iii) at least 6 hours; (iv) at least 10 hours; (v) at least 24 hours; and (vi) at least 48 hours.

The thickness of the thin film is relatively thin, such as at least one of: (i) about 10 um or less, (ii) about 1 um or less, and (iii) about 0.1 um or less. Additionally or alternatively, the surface roughness of the thin film is relatively low, such as at least one of: (i) about 10 nanometers RMS or less, and (ii) about 1 nanometer RMS or less.

By way of example, the material of the thin film may include an inorganic oxide, such as taken from the group consisting essentially of: SiO2, TiO2, Al2O3, ZrO2, CeO2, Fe2O3, BaTiO3, MgO, SnO2, B2O3, P2O5, PbO, indium-tin-oxide, fluorine-doped tin oxide, antimony-doped tin oxide, Zinc Oxide (ZnO), AZO (aluminum-zinc-oxide) and FZO (fluorine-zinc-oxide), mixtures thereof, and doped versions thereof.

Alternatively, the material of the thin film includes a hybrid organic-inorganic material, such as one of an organically modified silicate, a siloxane, a silsesquioxane, and combinations thereof.

Alternatively, the material of the thin film includes a non-oxide, such as taken from the group consisting essentially of: fluorides, nitrides, carbides, and combinations thereof.

Alternatively, the material of the thin film includes a mixed-composition, such as one of an oxynitride, an oxycarbide, and combinations thereof.

The boiling point of the solvent is carefully selected, such that the solvent boiling point threshold is at least one of: above about 140° C., and above about 175° C.

Additionally or alternatively, the solvent viscosity threshold (at room temperature) of the solvent is carefully selected, such that the solvent viscosity threshold is at least one of below about 6 centipoise (cP) and below about 15 centipoise. In addition, the viscosity of the entire mixture (sol-gel and all solvents) is at least one of below about 6 centipoise (cP) and below about 15 centipoise.

The solvent may include material taken from the group consisting essentially of: dipropylene glycol monomethyl ether (DPM), tripropylene glycol monomethyl ether (TPM), propylene glycol methyl ether acetate (PGMEA), and combinations thereof.

Additionally or alternatively, the solvent may include a polar aprotic solvent, such as taken from the group consisting essentially of: dimethylformamide (DMF), n-methyl pyrrolidone (NMP), dimethylacetimide (DMAc), dimethylsulfoxide (DMSO), cyclohexanone, acetophenone, and combinations thereof.

Additionally or alternatively, the solvent may include material taken from the group consisting essentially of: 2-isopropoxyethanol, diethylene glycol monoethyl ether, and combinations thereof.

Proportions of the solvent to the mixture are also carefully considered. For example, when the solvent includes dipropylene glycol monomethyl ether (DPM), the mixture may contain one of: (i) between 0.1%-95% of the dipropylene glycol monomethyl ether (DPM) by volume, and (ii) between 1%-60% of the dipropylene glycol monomethyl ether (DPM) by volume.

Additionally or alternatively, when the solvent includes tripropylene glycol monomethyl ether (TPM), the mixture may contain one of: (i) between 0.1%-50% of the tripropylene glycol monomethyl ether (TPM) by volume, and (ii) between 1%-20% of the tripropylene glycol monomethyl ether (TPM) by volume.

Additionally or alternatively, when the solvent includes a combination of dipropylene glycol monomethyl ether (DPM) and tripropylene glycol monomethyl ether (TPM), the mixture may contain between 1%-60% of the dipropylene glycol monomethyl ether (DPM) by volume, and the mixture may contain between 1%-20% of the tripropylene glycol monomethyl ether (TPM) by volume.

Additionally or alternatively, when the solvent includes propylene glycol methyl ether acetate (PGMEA), the mixture may contain one of: (i) between 1%-30% of the propylene glycol methyl ether acetate (PGMEA) by volume, and (ii) between 1%-20% of the propylene glycol methyl ether acetate (PGMEA) by volume.

In one or more preferred embodiments, the mixture may contain one of: (i) greater than 20% by volume of one, or a combination, of the above-mentioned high-boiling, low-viscosity solvents, and (ii) greater than 50% by volume of one, or a combination, of the above-mentioned high-boiling, low-viscosity solvents, and (iii) greater than 80% by volume of one, or a combination, of the above-mentioned high-boiling, low-viscosity solvents.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is an elevational, schematic view of a structure employing a substrate and a thin film in accordance with one or more embodiments described and/or disclosed herein;

FIGS. 2A, 2B, and 2C are schematic illustrations of a process in which the structure of FIG. 1 may be produced in accordance with one or more further embodiments described and/or disclosed herein;

FIG. 3 is a process flow diagram illustrating process steps that may be carried out to produce the structure of FIG. 1 in accordance with one or more still further embodiments described and/or disclosed herein;

FIGS. 4A and 4B are optical images representing a uniformity of thickness of a thin film having been disposed on a glass substrate in accordance with different sol-gel and solvent processes for purposes of comparison; and

FIG. 5 is a graph illustrating the relationship between specular reflectance in percent (on the Y-axis) and light wavelength in nm (on the X-axis) as between a bare glass substrate (upper graph) and a glass substrate spray coated with a sol-gel and solvent mixture suitable for an anti-reflective coating in accordance with one or more still further embodiments described and/or disclosed herein.

### DETAILED DESCRIPTION OF THE PREFERRED EMBODIMENTS

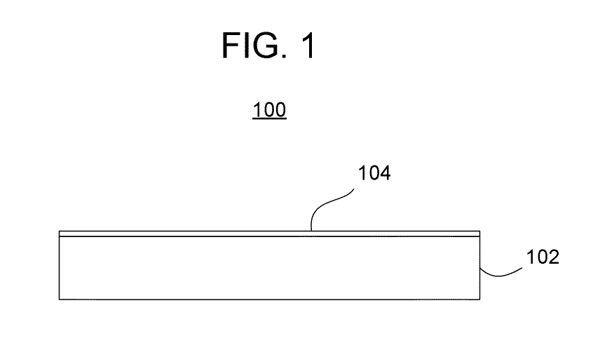

With reference to the drawings wherein like numerals indicate like elements there is shown in FIG. 1 a structure 100 having a substrate 102 and a thin film 104 disposed thereon. Although the structure 100 is suitable for any number of applications, one non-limiting application is an optical application in which a glass or glass-ceramic substrate 102 is coated with a substantially transparent, anti-reflective thin film 104. Irrespective of the particular application, the structure 100 is produced using one or more novel methodologies and/or formulations, specifically relating to the application of the thin film 104 onto the surface of the substrate 102.

### General Considerations

### Substrate

The substrate 102 may be formed of any suitable material, such as a polymer, glass, glass-ceramic, quartz, or other material. When the substrate 102 is formed of glass or glass ceramic materials, then any suitable glass composition may be employed, such as soda lime glass (SiO2, Na2O, CaO, etc.), metallic alloy glasses, ionic melt glass, polymer glasses (acrylic glass, polycarbonate, polyethylene terephthalate), etc.

As will be discussed in more detail later herein, in some applications the substrate 102 should exhibit high strength (such as in automotive applications). In such applications, the strength of conventional glass may be enhanced by chemical strengthening (ion exchange). Glass compositions that are suitable for ion-exchange include alkali aluminosilicate glasses or alkali aluminoborosilicate glasses (e.g., containing at least 2-4 mol % of Al2O3 or ZrO2), although other glass compositions are contemplated. Ion exchange (IX) techniques can produce high levels of compressive stress in the treated glass, as high as about 400-1000 MPa at the surface, and are suitable for very thin glass. In addition, the ion-exchange depth of layer may preferably be in the range of about 15-50 microns. One such IX glass is Corning® Gorilla Glass® (Code 2318) available from Corning Incorporated.

In the illustrated example, the substrate 102 is substantially planar, although other embodiments may employ a curved or otherwise shaped or sculpted substrate 102. Additionally or alternatively, the thickness of the substrate 102 may vary, for aesthetic and/or functional reasons, such as employing a higher thickness at edges of the substrate 102 as compared with more central regions.

### Thin Film

In preferred embodiments, the thin film 104 exhibits very high quality characteristics, such as for precision optical coatings, where the film 104 often needs to be very thin, of high uniformity in thickness, and of low surface roughness. By way of example, the thickness of the thin film 104 is at least one of: (i) about 10 um or less, (ii) about 1 um or less, and (iii) about 0.1 um or less. Additionally or alternatively, the surface roughness of the thin film 104 is at least one of: (i) about 10 nanometers RMS or less, and (ii) about 1 nanometer RMS or less.

The specific material and composition of the thin film 104 may be selected from any of a number of suitable candidates, which will be apparent to skilled artisans from the disclosure herein. For example, the material of the thin film 104 may include an inorganic oxide, such as taken from the group consisting essentially of: SiO2, TiO2, Al2O3, ZrO2, CeO2, Fe2O3, BaTiO3, MgO, SnO2, B2O3, P2O5, PbO, indium-tin-oxide, fluorine-doped tin oxide, antimony-doped tin oxide, Zinc Oxide (ZnO), AZO (aluminum-zinc-oxide) and FZO (fluorine-zinc-oxide), mixtures thereof, and doped versions thereof. Alternatively, the material of the thin film 104 may include a non-oxide, such as taken from the group consisting essentially of: fluorides, nitrides, carbides, and combinations thereof. Additionally or alternatively, the material of the thin film 104 may include various hybrid organic-inorganic materials that are known in the art, such as organically modified silicates, siloxanes, silsesquioxanes, and combinations thereof. Additionally or alternatively, the material of the thin film 104 may include a mixed-composition, such as including an oxynitride, an oxycarbide, and/or combinations thereof.

### Methodology and Formulation

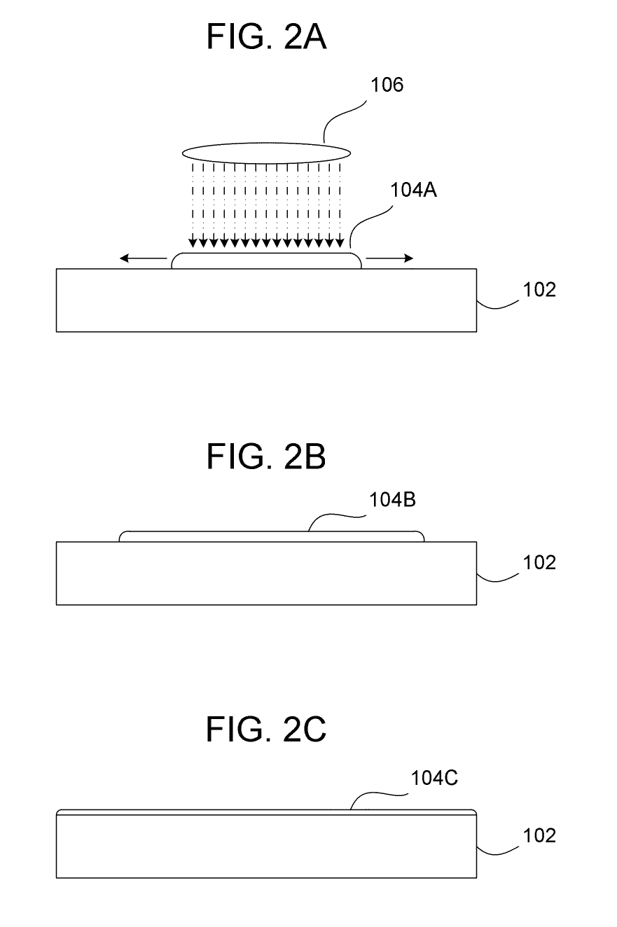

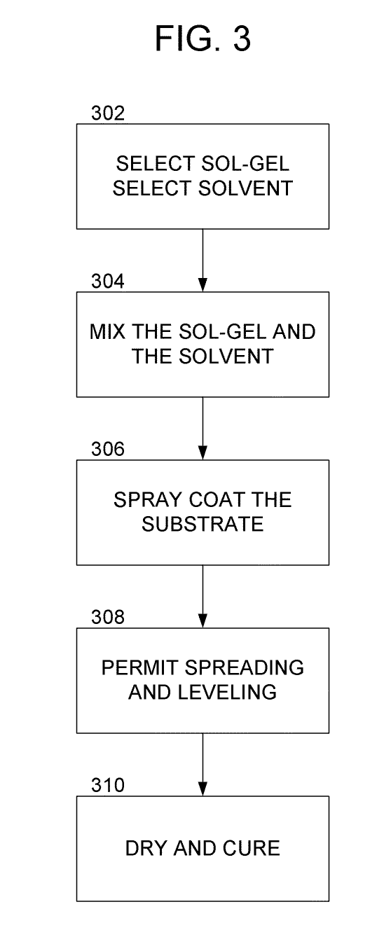

With reference to FIGS. 2A, 2B, 2C, and 3, the methodology and formulations employed in producing the structure 100 are of significance. Indeed, it is desirable to employ a sol-gel process to form a high-quality, relatively thin film 104 on the substrate 102, preferably using a spray coating process.

Although both sol-gel processes and spray coating processes have been used separately (and to a much lesser extent in combination), the ability to achieve very thin, uniformly thick, and low surface roughness films 104 is by no means routine in the existing state of the art. While some may claim that spray coating is a viable option for application of sol-gels to substrates, the reality is that conventional spray coating techniques and formulations are woefully deficient in connection with achieving very thin, uniformly thick, and low surface roughness films 104. Consequently, the conventional wisdom in the art is that spray coating processes are generally not employed commercially in the production of precision thin film coatings, such as precision optical coatings where very good control of layer thickness and roughness is required. It is noted that “very good control” of layer thickness may be defined to include a continuous thin film coating with a standard deviation of layer thickness of less than about 10% of the average layer thickness. Alternatively, the standard deviation of layer thickness may be less than about 5% of the average thickness. In preferred embodiments, the standard deviation of layer thickness may be less than about 3% of the average thickness.

With reference to FIGS. 2-3, the process of producing the structure 100 includes preparing the substrate 102 to receive a sol-gel. By way of example, the substrate 102 may be acid polished or otherwise treated to remove or reduce the adverse effects of surface flaws. The substrate 102 may also be cleaned or pre-treated to promote adhesion of the applied sol-gel. For example, when the substrate 102 is a glass material, the surface thereof may be suitably treated to promote the formation of reactive hydroxyl groups thereon.

With reference to FIG. 3, the sol-gel is selected to contain one or more suitable solids (e.g., inorganic oxide(s) or other desired solid(s)), liquids, and/or gels (action 302). Also at action 302, and as will be discussed in much greater detail later herein, a solvent is selected to complement the selected sol-gel formulation, particularly to promote desirable spraying characteristics, spreading characteristics, and leveling characteristics. At action 304, the selected sol-gel and solvent are merged together to form a mixture.

Alternatively or additionally, the selected sol-gel may be synthesized in the presence of the selected solvent. That is, using conventional terminology, a “sol-gel precursor” material such as tetraethylorthosilicate (TEOS) (or any various precursors known in the art, including alkoxides, nitrates, and the like) may be mixed with the selected solvent before the TEOS is reacted to form a sol-gel or colloid. Then, the TEOS may be reacted into a sol-gel or colloid when it is already mixed with the selected solvent.

The mixture of the sol-gel 104 is loaded into an applicator 106 (FIG. 2A). In a preferred embodiment, the applicator 106 includes an ultrasonic spray nozzle having a suitable capacity and flow rate to make an initial application of the sol-gel 104A to the surface of the substrate 102 through spray coating techniques (action 306). With reference to FIGS. 2B-2C, the applied sol-gel and solvent mixture is permitted to spread and level 104B and 104C when given sufficient time (action 308). As alluded to above, the selection of components of the mixture, i.e., the sol-gel, the solvent, and other elements (collectively shown as a spreading and leveling liquid 104A, 104B, 104C) may be useful in achieving a very thin, uniformly thick, and low surface roughness film 104. Indeed, it has been discovered that employing a mixture of the sol-gel and slow-drying solvent(s), which nevertheless exhibits relatively low viscosity and is compatible with the sol-gel formulation, achieves the desired characteristics of the thin film 104, both during application of the mixture and thereafter. At action 310, the leveled mixture 104C is then dried and/or cured to form a hard, thin layer 104 on the substrate 102.

An additional discussion of the process of selecting the sol-gel and selecting the solvent will be presented. Once the precursor sol-gel composition is determined (i.e., the desired materials for forming a thin film layer 104 are selected), particular attention should be made to the formulation of the solvent alone, and to the mixture of the sol-gel and the solvent.

In general, the solvent should have a boiling point at or above a so-called solvent boiling point threshold and a viscosity at or below a so-called solvent viscosity threshold. These parameters contribute greatly to the stability of the mixture for a time period sufficient to achieve the spreading and leveling steps (action 308). In this regard, being “stable” includes stability of the solution of the sol-gel, where such stability is characterized by at least one of: substantially no aggregation or growth of colloidal material in the solution, substantially no rapid change in viscosity, substantially no unstable viscosity in storage, substantially no cloudiness, and substantially no gellation. For example, being stable includes the ability to exhibit substantially no viscosity change in the mixture when subject to storage for at least one of: (i) at least 2 hours, (ii) at least 4 hours; (iii) at least 6 hours; (iv) at least 10 hours; (v) at least 24 hours; and (vi) at least 48 hours.

By way of example, it has been discovered that suitable characteristics of the mixture of the sol-gel and the solvent have been obtained when the solvent boiling point threshold is between about 140° C. and about 175° C., in other words, that the boiling point is at or above at least 140° C., and in some embodiments at or above at least about 175° C. It has also been discovered that suitable characteristics of the mixture of the sol-gel and the solvent have been obtained when, concurrent with the solvent boiling point threshold, the solvent viscosity threshold is between about 6 centipoise (cP) and about 15 centipoise (cP), in other words that the solvent viscosity is at or below about 15 centipoise (cP), and in some embodiments at or below at least about 6 centipoise (cP).

In most cases, it will also be desirable that the major solvents of the mixture (i.e., those present in greater than about 20% by volume of the mixture, and/or those with the highest boiling point in the mixture) have a polarity greater than about 30, and in some cases a polarity greater than about 50. These polar solvents show the greatest compatibility with some sol-gel materials, which manifests as a stable sol-gel solution that does not agglomerate, is stable in storage, and results in smooth thin film coatings. The polarity parameter used here is an empirical parameter determined by the position of the maximum absorption band of the betaine dye in the presence of tested substance (as in Smallwood, I. M., 1996. Handbook of Organic Solvent Properties, Elsevier). In addition, the selection of these polar solvents, which also meet the above-stated high-boiling and low-viscosity requirements, will facilitate creation of a sol-gel and solvent mixture where the overall mixture (and not just the individual components) has a viscosity below about 6.0 cP.

Taking the above solvent boiling point and solvent viscosity parameters into consideration (together with the formulation considerations of the sol-gel), the solvent may include a carefully selected set of materials. For example, the solvent may include material taken from the group consisting essentially of: dipropylene glycol monomethyl ether (DPM), tripropylene glycol monomethyl ether (TPM), propylene glycol methyl ether acetate (PGMEA), and combinations thereof.

For example, the solvent may include dipropylene glycol monomethyl ether (DPM), and the mixture may contain one of: (i) between 0.1%-95% of the DPM by volume, and (ii) between 1%-60% of the DPM by volume.

Additionally or alternatively, the solvent may include tripropylene glycol monomethyl ether (TPM), and the mixture may contain one of: (i) between 0.1%-50% of the TPM by volume, and (ii) between 1%-20% of the TPM by volume.

In one or more embodiments, the solvent may include a combination of dipropylene glycol monomethyl ether (DPM) and tripropylene glycol monomethyl ether (TPM), where the mixture contains between 1%-60% of the dipropylene glycol monomethyl ether (DPM) by volume, and the mixture contains between 1%-20% of the tripropylene glycol monomethyl ether (TPM) by volume.

In one or more further embodiments, the solvent may include propylene glycol methyl ether acetate (PGMEA), and the mixture may contains one of: (i) between 1%-30% of the propylene glycol methyl ether acetate (PGMEA) by volume, and (ii) between 1%-20% of the propylene glycol methyl ether acetate (PGMEA) by volume. Notably, a preferred range of propylene glycol methyl ether acetate (PGMEA) within the mixture is less than about 20% by volume, and is combined with other mixture elements that are not acetates.

In a preferred embodiment, the thin film 104 is a substantially transparent, anti-reflective coating on the substrate 102, comprising SiO2 and TiO2. In order to achieve this combination, during production, the sol-gel contains SiO2 and/or TiO2 deposited in successive layers, and the solvent includes dipropylene glycol monomethyl ether (DPM) of between 20%-60% by volume in the mixture. The solvent may also include tripropylene glycol monomethyl ether (TPM), of between 2%-8% by volume in the mixture.

In one or more still further embodiments, for example, the solvent may additionally or alternatively include a polar aprotic solvent, such as taken from the group consisting essentially of: dimethylformamide (DMF), n-methyl pyrrolidone (NMP), dimethylacetimide (DMAc), dimethylsulfoxide (DMSO), cyclohexanone, acetophenone, and combinations thereof.

In one or more still further embodiments, for example, the solvent may additionally or alternatively include material taken from the group consisting essentially of: 2-isopropoxyethanol, diethylene glycol monoethyl ether, and combinations thereof.

### Further Considerations

### Substrate Ion Exchange Glass

In applications where the substrate 102 should exhibit high strength (such as in automotive applications), the strength of conventional glass may be enhanced by chemical strengthening (ion exchange). Ion exchange (IX) techniques can produce high levels of compressive stress in the treated glass, as high as about 400-1000 MPa at the surface, and is suitable for very thin glass. One such IX glass is Corning® Gorilla Glass® (Code 2318) available from Corning Incorporated.

Ion exchange is carried out by immersion of a glass sheet into a molten salt bath for a predetermined period of time, where ions within the glass sheet at or near the surface thereof are exchanged for larger metal ions, for example, from the salt bath. By way of example, the molten salt bath may include KNO₃, the temperature of the molten salt bath may within the range of about 400-500° C., and the predetermined time period may be within the range of about 2-24 hours, and preferably between about 2-10 hours. The incorporation of the larger ions into the glass strengthens the sheet by creating a compressive stress in a near surface region. A corresponding tensile stress is induced within a central region of the glass sheet to balance the compressive stress. Sodium ions within the glass sheet may be replaced by potassium ions from the molten salt bath, though other alkali metal ions having a larger atomic radius, such as rubidium or cesium, may replace smaller alkali metal ions in the glass. According to particular embodiments, alkali metal ions in the glass sheet may be replaced by Ag+ ions. Similarly, other alkali metal salts such as, but not limited to, sulfates, halides, and the like may be used in the ion exchange process.

The replacement of smaller ions by larger ions at a temperature below that at which the glass network can relax produces a distribution of ions across the surface of the glass sheet that results in a stress profile. The larger volume of the incoming ion produces a compressive stress (CS) on the surface and tension (central tension, or CT) in the center region of the glass. The compressive stress is related to the central tension by the following relationship:

$$CS = CT ( \frac{t - 2 DOL}{DOL} )$$

where t is the total thickness of the glass sheet and DOL is the depth of exchange, also referred to as depth of compressive layer. The depth of compressive layer will in some cases be greater than about 15 microns, and in some cases greater than 20 microns, to give the highest protection against surface damage.

Any number of specific glass compositions may be employed in producing the glass sheet. For example, ion-exchangeable glasses that are suitable for use in the embodiments herein include alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

### EXAMPLES

### General Conditions

A number of experiments were conducted in laboratory conditions in order to evaluate aspects of the embodiments discussed above and other embodiments supported by the disclosure herein. In the Examples discussed in detail below, an ultrasonic spray coating process was used to apply mixtures of sol-gels and solvents to glass substrates. The ultrasonic spray coating parameters included a single 120 kHz ultrasonic spray nozzle, a nozzle power of 3.0-5.0 watts, a flow rate of 300-500 uL/min, and a shaping fan air at 0.5-1 psi. The spray coating was performed using a single nozzle raster pattern with a distance between passes of 10 mm and a spray nozzle height of 3-4 cm from the surface of the glass substrate. Prior to coating, all glass substrates were cleaned in a heated ultrasonic bath containing 4% Semi-Clean KG (KOH detergent).

### Example 1

In this example, a single layer, optically uniform, TiO2 sol-gel thin film coating was achieved on a number of substrates of Corning 2318 glass (which is a strengthened glass prepared using ion exchange processes).

A solution (Sol 1) was prepared by mixing 126.5 mL of ethanol with 2.86 mL of deionized (DI) water and 0.64 mL of HNO3 (of 69% concentration). The mixture was stirred for 5 minutes at room temperature, after which 12.12 mL of titanium (IV) isopropoxide was added and the solution was further stirred for 1 hour at room temperature. Thereafter Sol 1 was ready for further use.

A mixture of the Sol 1 and a solvent was prepared by combining the following: 35:10:50:5 parts by volume of Sol-1:ethanol:DPM:TPM.

The mixture of the sol-gel and solvent was sprayed onto the glass surfaces of the substrates at a nozzle translation velocity of about 30 mm/sec. Next, the applied mixture was permitted to level and at least partially dry at room temperature in air for about 20 minutes. Next, the applied mixture was dried using a conveyor-belt IR heater at 115° C. for 60 seconds, followed by 150° C. for 60 seconds. The thin films were then cured at 315° C. in an air environment for 2 hours.

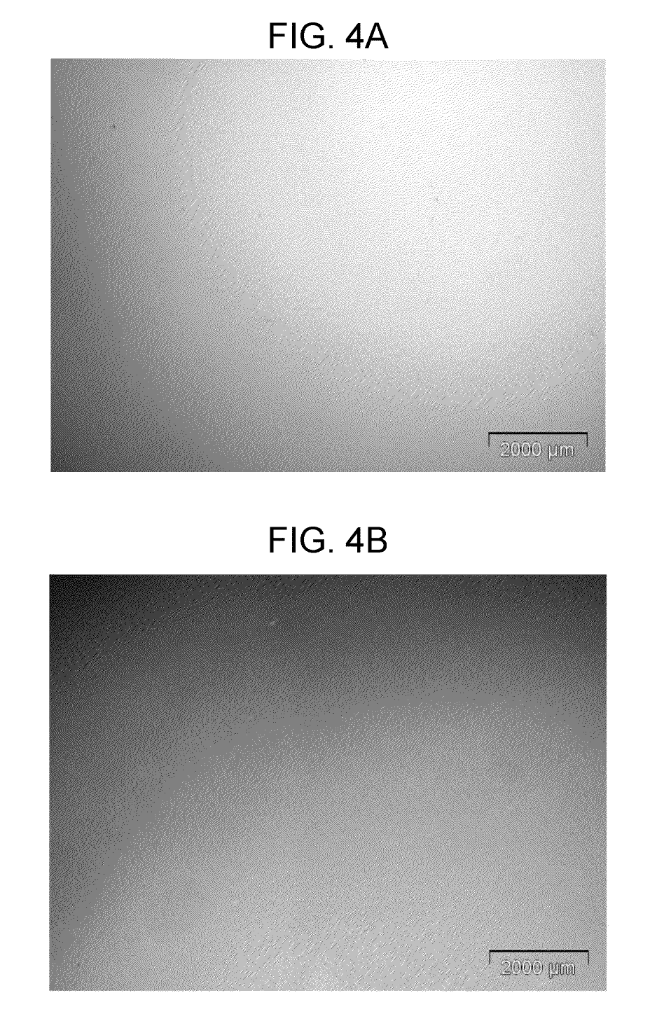

Reference is made to FIG. 4A, which is an optical image representing the uniformity of thickness of the thin film of one of the samples. The representative image and related spectroscopic data reveals that the resulting thin film coatings had thicknesses of about 64 nm and refractive indices of about 2.05 at 550 nm. The thin films were optically homogenous (directly correlating to the thickness uniformity) as determined by visual inspection and optical inspection via microscope. The typical roughness of the thin films measured using profilometry was less than about 1 nanometer RMS.

### Comparative Example 1

A number of samples were prepared by varying the parameters of Example 1 in order to evaluate the complexities and subtleties of the sol-gel and solvent interactions.

A solution (Sol C1) was prepared by mixing 253 mL of ethanol with 5.72 mL of DI water and 1.28 mL of HNO3 (of a 69% concentration). The mixture was stirred for 5 minutes at room temperature, after which 12.12 mL of titanium (IV) isopropoxide was added and the mixture was further stirred for 1 hour at room temperature.

A mixture of the Sol C1 and a solvent was prepared by combining 50:25:20:5 parts by volume of Sol C1:2-isopropoxyethanol:PGMEA:2-butoxyethanol.

The resultant mixture retained clarity and relatively low viscosity, which permitted spray-coating a number of substrates. The samples were evaluated by employing various coating speeds and flow rates. The applied mixtures were permitted to level and at least partially dry in air for approximately 20 minutes.

Reference is made to FIG. 4B, which is an optical image representing the uniformity of thickness of one of the thin films (and which may be compared with the representation of FIG. 4A). Although continuous coated thin films were obtained across the samples, the productions of thin optical interference layers resulted in noticeable color variations in all samples across many coating conditions. By way of example, the color variations manifested in reflected color from red to blue, which typically denotes a variation of greater than 20% in the thickness of the thin film in multiple regions of the sample.

This comparative example reveals the complex interaction as between the sol-gel properties and the solvent properties. Indeed, although the formulation may be used for spray coating of sol-gel films onto substrates, the indication is that, due to the relatively fast drying behavior as well as less preferred viscosity levels and sol-gel compatiblity, the mixture properties are not as effective and robust as other formulations herein, which resulted in uniform thin layers with suitable optical interference layers.

### Example 2

In this example, an anti-reflective thin film coating was achieved on a substrate, which exhibited suitable optical performance owing to the care taken in evaluating the sol-gel and solution interactions and the desired final optical characteristics. The methodology involved a multi-layer procedure resulting in a multi-layer thin film on the substrate. It is noted that the leveling of sol-gel and solvent mixture on an existing layer formed from a sol-gel is not a trivial procedure, especially with a relatively short drying step in between layers. For example, the presence of organic materials within/on the underlying layer makes wettability extremely difficult.

A first sol-gel (Sol 1) was prepared by mixing 126.5 mL of ethanol with 2.86 mL of DI water and 0.64 mL of HNO3 (69% concentration). The mixture was stirred for 5 minutes at room temperature, after which 12.12 mL of titanium (IV) isopropoxide was added, and the mixture was further stirred for 1 hour at room temperature.

A second sol-gel (Sol 2) was prepared by mixing 200 mL of methanol with 25 mL of tetraethyl orthosilicate and 25 mL of 0.01M HCl in water. The mixture was stirred under reflux heating for 2 hours, after which it was cooled to room temperature.

A first sol-gel and solvent mixture was prepared by combining 25.5:24.5:17:28:5 parts by volume of Sol 1:Sol 2:ethanol:DPM:TPM. The first mixture was spray coated onto a number of glass substrates at a nozzle translation velocity of about 41 mm/sec. The resultant first mixtures were permitted to level and at least partially dry at room temperature for 15 minutes, after which they were dried using a conveyor-belt IR heater at 115° C. for 60 seconds and 150° C. for 120 seconds. The resulting first layers of thin films were then cured at 315° C. in air for 2 hours before a next layer was applied.

The resulting first layers of thin films were also measured individually before additional layers were applied. The measurements indicated intermediate refractive indices of about 1.67 at 550 nm and thicknesses close to 80 nm. The measurements also revealed that the first layers of thin films were optically homogeneous (e.g., that any inhomogeneity was less than 20 nm in size), optically clear, and had substantially no optical scattering.

A second sol-gel and solvent mixture was prepared by combining 35:10:50:5 parts by volume of Sol 1:ethanol:DPM:TPM. The second mixture was sprayed atop the first layers of thin films at a nozzle translation velocity of 30 mm/sec. The second mixtures were permitted to level and at least partially dry at room temperature for 20 minutes, after which they were dried and partially cured using a conveyor-belt IR heater at 115° C. for 60 seconds, 150° C. for 60 seconds, and 190° C. for 180 seconds. The substrates were then coated a second time using the second mixture (to achieve a total desired thickness for the second layer) using the same second mixture at a velocity of about 30 mm/sec, after which they were permitted to level and at least partially dry for 20 minutes at room temperature, then dried using a conveyor-belt IR heater at 115° C. for 60 seconds and 150° C. for 120 seconds. The resultant second thin films were then cured at 315° C. in air for 2 hours before applying any further layers.

A third sol-gel and solvent mixture was prepared by combining 38:32:25:5 parts by volume of Sol 2:ethanol:DPM:TPM. The third mixture was sprayed onto the samples on top of the second layer (which as discussed above included two sub layers) at a nozzle translation velocity of approximately 36 mm/sec. The third mixtures were permitted to level and at least partially dry at room temperature for 15 minutes, after which they were dried using a conveyor-belt IR heater at 115° C. for 60 seconds and 150° C. for 120 seconds. The resultant third films were then cured at 315° C. in air for 2 hours before final testing and measurement.

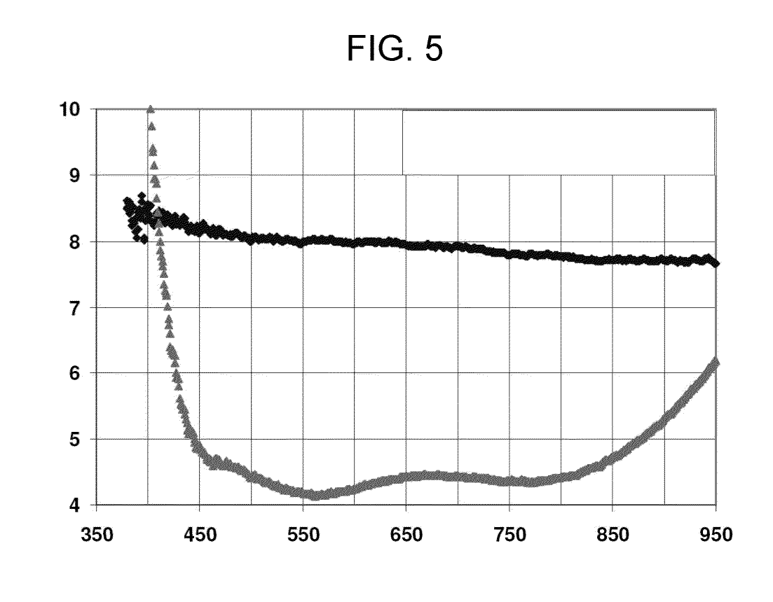

Reference is made to FIG. 5, which is a graph illustrating the relationship between specular reflectance in percent (on the Y-axis) and light wavelength in nm (on the X-axis) as between a bare glass substrate (upper graph) and the resultant AR coating formed on the substrate in this example. The resulting three-layer AR coating demonstrated a single-side reflectance of less than 1% across a broad wavelength range of 450-850 nm, with single-side reflectance less than 0.5% at 550 nm. It is noted that single-side reflectance was calculated for a one-sided coating by subtracting one half of the bare glass control reflectance value from the AR sample reflectance value. In this case, about 4% was subtracted from the AR sample reflectance value, to take out the contribution of the bare glass reflection of the uncoated surface. The pencil hardness of the respective AR coatings measured about 3H or better. Typical roughness of the multilayer AR coatings, measured using profilometry, was less than 1 nanometer RMS. Typical standard deviations in layer thickness, which was calculated using optical modeling based on optical spectroscopy measurements, was found to be less than about 5% of the average layer thicknesses.

### Example 3

In this example, another multi-layer anti-reflective thin film coating was achieved on a substrate using similar process steps as discussed above in Example 2 (including the same sol formulations and spray parameters), however, a modified curing process was employed. Rather than performing a 315° C. cure between each layer, a shorter IR curing process was used between each layer. Specifically, between, each layer, the respective mixture was dried and partially cured using an IR heater at 115° C. for 60 seconds, 150° C. for 60 seconds, and 190° C. for 180 seconds. The sample was allowed to cool for about 10 minutes and then the next layer of mixture was applied. After all layers had been applied, and only then, the sample was cured at 315° C. for 2 hours in air. This modified curing process was faster and more efficient than the process in Example 2.

The optical results for the AR coating of this example were similar to Example 2, however, the pencil hardness of this example was notably improved and was measured to be about 6H or better.

### Example 3 Extended

In this extended experiment, certain of the samples from Example 3 (specifically those samples on non-strengthened, but ion-exchangeable glass) were subjected to an ion-exchange process. The specific process included immersion of the samples (which the AR coating as in Example 3) into a molten KNO3 bath at 420° C. for 5.5 hours. The AR coating showed good durability to the harsh conditions of the IX process, substantially retaining the desired AR and durability properties, while demonstrating sufficient diffusive permeability to substantially allow the ion-exchange of the coated glass surface in a similar manner to the uncoated glass surface, resulting in comparable glass surface compressive stress levels.

### Example 4

In this example, a single layer, optically uniform, SnO2 sol-gel thin film coating was achieved on a number of substrates of Corning 2318 glass.

A solution (Sol 3) was prepared by mixing 100 mL of ethanol with 1 mL of 1M HCl and stirred for at least 5 minutes. The solution was then mixed with 8.0 grams of Tin(IV) chloride pentahydrate and stirred for 45 minutes at room temperature, which dissolved all of the tin salts. The solution was then transferred to a heated flask and stirred under reflux heating at or near the boiling point of ethanol for 1 hour. Sol 3 was then cooled and refrigerated for 5 days at 4° C.

After 5 days, 10 mL of the Sol 3 was mixed with 10 mL of dipropylene glycol monomethyl ether, and deposited on an alkali aluminosilicate glass substrate (an ion-exchangeable glass) using ultrasonic spray coating as in previous examples, in this case using a nozzle translation speed of 15 mm/sec. After drying and curing at 550° C. for 2 hours, the thin film was approximately 50 nm thick and was clear and free of visible haze. XPS results confirm that the final composition of the thin film was primarily SnO2 with minor contaminants (see table below, Example 5).

### Example 5

In this example, a single layer, optically uniform, hybrid SnO2-SiO2 sol-gel thin film coating was achieved on a number of substrates of Corning 2318 glass in order to evaluate the resulting composition of the thin films.

In this example, a solution (Sol 5) was made by mixing 6 mL of Sol 3 with 4 mL of Sol 2, where a TEOS-based SiO2 precursor was prepared as in our previous examples. The resulting solution was mixed with 10 mL of dipropylene glycol monomethyl ether, followed by ultrasonic spray coating using similar spray parameters as in previous examples. The composition of the final films was analyzed by XPS, and is shown in the table below.

| Sample | Area | O | F | Na | Si | Cl | K | Sn |
|---|---|---|---|---|---|---|---|---|
| Example 4 | A1 | 59.0 | 4.0 | 6.4 | — | 1.3 | — | 29.3 |
| Coated | A2 | 58.1 | 3.9 | 7.9 | — | 1.9 | — | 28.2 |
| Side | | | | | | | | |
| Example 5 | A1 | 64.0 | 1.8 | 4.3 | 8.2 | 0.1 | 0.2 | 21.4 |
| Coated | A2 | 65.5 | 1.4 | 3.9 | 8.7 | 0.1 | 0.2 | 20.2 |
| Side | | | | | | | | |

### Comparative Examples 2-6

A number of samples were prepared by varying the parameters of Examples 1-3 in order to further evaluate the complexities and subtleties of the sol-gel and solvent interactions. In particular, the ratios of the mixture were varied, while maintaining the same drying/curing processes in order to evaluate and demonstrate the changes in characteristics of the resulting thin film (particularly the optical properties) that result from changes in the balance of the sol-gel and solvent in the mixtures.

The process of Comparative Example 1 was carried out, where the mixture C2 was adjusted to be 50:10:35:5 parts by volume of Sol C1:2-isopropoxyethanol:PGMEA:ethylene glycol.

The process of Comparative Example 1 was carried out, where the mixture C3 was adjusted to be 50:35:15 parts by volume of Sol C1:PGMEA:ethylene glycol.

The process of Comparative Example 1 was carried out, where the mixture C4 was adjusted to be 50:42:8 parts by volume of Sol C1:PGMEA:ethylene glycol.

The above adjusted mixtures all became visibly cloudy after overnight storage at 4° C., meaning the mixtures were relatively unstable compared to mixtures of Examples 1-3. This reveals that such variation in the mixtures may make them impractical for certain applications and may result in thin films that are not uniform, not transparent, and hazy. The mixtures may also be unsuitable for industrial spray coating because there could be agglomeration or gelation in the sol, and the sols demonstrate unstable flow properties after even short storage times.

A number of samples were prepared by varying the parameters of Example 1 in order to further evaluate the complexities and subtleties of the sol-gel and solvent interactions. A modified solution (Sol C5) was made by mixing 126.5 mL of 2-isopropoxyethanol with 5.72 mL of DI water and 1.28 mL of HNO3 (69% concentration). The mixture was stirred for 5 minutes at room temperature, after which 12.12 mL of titanium (IV) isopropoxide was added and the solution was further stirred for 1 hour at room temperature. The Sol C5 by itself was clear and maintained a relatively low viscosity.

A mixture C5 was made by combining 70:25:5 parts by volume of Sol C5:1-methoxy-2-propanol:ethylene glycol. The mixture C5 became cloudy after 1 hour and showed a dramatic increase in viscosity after storage overnight, making this mixture impractical for use in industrial spray coating processes.

A solution (Sol C6) was obtained by mixing 253 mL of 2-isopropoxyethanol with 5.72 mL of DI water and 1.28 mL of HNO3 (69% concentration). The mixture was stirred for 5 minutes at room temperature, after which 12.12 mL of titanium (IV) isopropoxide was added and the solution was further stirred for 1 hour at room temperature. The Sol C6 by itself was clear and maintained a relatively low viscosity.

A mixture C6 was made by combining 70:25:5 parts by volume of sol C6:PGMEA:ethylene glycol. The mixture showed a dramatic increase in viscosity after storage overnight, making this mixture impractical for use in industrial spray coating.

In related experiments, it was discovered that when PGMEA is the slowest drying solvent or present in large amounts relative to other slow-drying solvents, clouding of the precursor resulted. Thus, PGMEA may be used in smaller amounts, but not when it is the slowest drying solvent, i.e., the last remaining solvent (or likely to be present in high concentrations relative to other slow-drying solvents) in the mixture during drying/curing. This is attributed in most cases to the relatively low polarity of PGMEA contributing to sol agglomeration.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application.

1. A method, comprising:
selecting a sol-gel precursor containing a material for forming a thin film layer on a substrate;
selecting a solvent having a boiling point at or above a solvent boiling point threshold and a viscosity at or below a solvent viscosity threshold;
combining the sol-gel and the solvent into a mixture;
applying the mixture onto a surface of the substrate;
permitting the mixture to spread and level on the surface; and
at least one of drying and curing the mixture to form the thin layer on the substrate.

2. The method of claim 1, wherein:
the mixture is stable for a time period sufficient to achieve the spreading and leveling step; and
being stable includes stability of a solution of the sol-gel, where such stability is characterized by at least one of: substantially no aggregation or growth of colloidal material in the solution, substantially no rapid change in viscosity, substantially no unstable viscosity in storage, substantially no cloudiness, and substantially no gellation.

3. The method of claim 2, wherein being stable includes the ability to exhibit substantially no viscosity change in storage for at least one of: (i) at least 2 hours, (ii) at least 4 hours; (iii) at least 6 hours; (iv) at least 10 hours; (v) at least 24 hours; and (vi) at least 48 hours.

4. The method of claim 1, wherein at least one of: (i) a thickness of the thin film is about 10 um or less, (ii) a thickness of the thin film is about 1 um or less, and (iii) a thickness of the thin film is about 0.1 um or less.

5. The method of claim 1, wherein at least one of: (i) a surface roughness of the thin film is about 10 nanometers RMS or less, and (ii) a surface roughness of the thin film is about 1 nanometer RMS or less.

6. The method of claim 1, wherein at least one of:
the material of the thin film includes an inorganic oxide; and
the inorganic oxide is taken from the group consisting essentially of: SiO2, TiO2, Al2O3, ZrO2, CeO2, Fe2O3, BaTiO3, MgO, SnO2, B2O3, P2O5, PbO, indium-tin-oxide, fluorine-doped tin oxide, antimony-doped tin oxide, Zinc Oxide (ZnO), AZO (aluminum-zinc-oxide) and FZO (fluorine-zinc-oxide), mixtures thereof, and doped versions thereof.

7. The method of claim 1, wherein at least one of: the solvent boiling point threshold is at least one of: at or above about 140° C., and at or above about 175° C.

8. The method of claim 1, wherein at least one of: the solvent viscosity threshold (at room temperature) is at least one of at or below about 6 centipoise (cP), and at or below about 15 centipoise.

9. The method of claim 1, wherein the solvent includes material taken from the group consisting essentially of: dipropylene glycol monomethyl ether (DPM), tripropylene glycol monomethyl ether (TPM), propylene glycol methyl ether acetate (PGMEA), and combinations thereof.

10. The method of claim 1, wherein at least one of:
the solvent includes a polar aprotic solvent; and
the polar aprotic solvent is taken from the group consisting essentially of: dimethylformamide (DMF), n-methyl pyrrolidone (NMP), dimethylacetimide (DMAc), dimethylsulfoxide (DMSO), cyclohexanone, acetophenone, and combinations thereof.

11. The method of claim 1, wherein the solvent includes material taken from the group consisting essentially of: 2-isopropoxyethanol, diethylene glycol monoethyl ether, and combinations thereof.

12. The method of claim 1, wherein at least one of:
the solvent includes dipropylene glycol monomethyl ether (DPM), and the mixture contains one of: (i) between 0.1%-95% of the dipropylene glycol monomethyl ether (DPM) by volume, and (ii) between 1%-60% of the dipropylene glycol monomethyl ether (DPM) by volume; and
the solvent includes tripropylene glycol monomethyl ether (TPM), and the mixture contains one of: (i) between 0.1%-50% of the tripropylene glycol monomethyl ether (TPM) by volume, and (ii) between 1%-20% of the tripropylene glycol monomethyl ether (TPM) by volume.

13. The method of claim 1, wherein the solvent includes a combination of dipropylene glycol monomethyl ether (DPM) and tripropylene glycol monomethyl ether (TPM), the mixture contains between 1%-60% of the dipropylene glycol monomethyl ether (DPM) by volume, and the mixture contains between 1%-20% of the tripropylene glycol monomethyl ether (TPM) by volume.

14. The method of claim 1, wherein the solvent includes propylene glycol methyl ether acetate (PGMEA), and the mixture contains one of: (i) between 1%-30% of the propylene glycol methyl ether acetate (PGMEA) by volume, and (ii) between 1%-20% of the propylene glycol methyl ether acetate (PGMEA) by volume, and (iii) a second solvent or combination of solvents with a higher boiling point than PGMEA, where the second solvent or combination of solvents is present in equal or greater quantities than the PGMEA.

15. The method of claim 1, further comprising:
selecting one or more such sol-gel precursors;
selecting one or more such solvents;
combining the sol-gel and the solvent into one or more such mixtures;
applying at least a first coating of at least one of the mixtures onto the surface of the substrate;
permitting the at least one mixture of the first coating to spread and level on the surface;
at least one of drying and curing the at least one mixture of the first coating to form the thin layer on the substrate; and
repeating the applying, leveling and spreading, and drying and curing steps for at least a second coating in order to produce a multi-level thin film on the substrate.

16. The method of claim 15, wherein at least one of:
the thin film is a substantially transparent, anti-reflective coating on the substrate, comprising SiO2 and TiO2; and
the solvent includes dipropylene glycol monomethyl ether (DPM) of between 20%-60% by volume in the mixture.

17. The method of claim 16, wherein the solvent includes tripropylene glycol monomethyl ether (TPM), of between 2%-8% by volume in the mixture.

18. The method of claim 1, wherein the step of applying the mixture includes spray coating the mixture onto the surface of the substrate.

19. The method of claim 1, wherein:
the solvent boiling point threshold is between about 140° C. and about 175° C.; and
the solvent viscosity threshold (at room temperature) is between about 6 centipoise (cP) and about 15 centipoise; and
the mixture excludes any solvents that do not meet the specified solvent viscosity threshold criteria.

20. A coating mixture, comprising:
a sol-gel inorganic oxide or hybrid organic-inorganic precursor containing a material for forming a thin film layer on a substrate;
a solvent having a boiling point at or above a solvent boiling point threshold and a viscosity at or below a solvent viscosity threshold; wherein
the solvent boiling point threshold is between about 140° C. and about 175° C.;
the solvent viscosity threshold (at room temperature) is between about 6 centipoise (cP) and about 15 centipoise; and
the mixture excludes any solvents that do not meet the specified solvent viscosity threshold criteria.
